(19) United States
(12) Patent Application Publication
(10) Pub. No.: US 2026/0154090 A1
(43) Pub. Date: Jun. 4, 2026

(54) METHOD FOR SCALABLE OPERATOR LOADING FOR PROGRAM MEMORY LIMITED ACCELERATORS

(71) Applicant: XILINX, INC., San Jose, CA (US)

(72) Inventors: Satyaprakash PAREEK, San Jose, CA (US); Bo QIAO, Beijing (CN); Jian WENG, Beijing (CN); Tejus SIDDAGANGAIAH, Broomfield, CO (US); Ashish SIRASAO, San Jose, CA (US)

(21) Appl. No.: 19/059,060

(22) Filed: Feb. 20, 2025

(30) Foreign Application Priority Data
Dec. 2, 2024 (WO) PCT/CN2024/136183

(51) Int. Cl. G06F 9/4401

(52) U.S. Cl. CPC G06F 9/4401

(57) ABSTRACT

A method includes allocating, at least one boot image, and parsing programs comprising one or more operators. The method further includes determining a count corresponding to each operator included in each program and an estimated program memory consumption of each operator. The count corresponds to each operator and indicates a quantity of times each operator in each program is detected. The at least one boot image is populated with common operators based on a program memory size limit of an hardware accelerator circuitry of an IC device and an estimated program memory consumption of each common operator. The common operators are operators that are within a threshold count. The at least one boot image is populated with non-common operators based on the program memory size limit and an estimated program memory consumption of each non-common operator. The non-common operators are operators that are not within the threshold count.

### TECHNICAL FIELD

Examples herein relate to artificial intelligence (AI) architectures. In particular, example herein relate partitioning programs to be executing by an AI engine.

### BACKGROUND

In artificial intelligence (AI) architectures, programs to be run in AI engines typically include operators that are performed during execution of the program. Operators are typically implemented using kernel that utilizes compute unit of the AI engine and wrapper code that communicates with an external memory. When a program is executed the program is loaded into a program memory of the AI engine which is typically limited by a memory capacity. However, standard operators used in a variety of programs such as a simple convolution kernel, or a sigmoid kernel quickly consume the entire memory capacity of the program memory. Thus, because the AI engine program memory can only support a few operators, programs quickly become unsalable on a per program basis.

Therefore, there is a need in the art for an AI engine that can support programs with the limited program memory capacity of AI engines.

### SUMMARY

According to one or more examples, a method includes allocating, by a central processing unit (CPU) of an integrated circuit (IC) device, at least one boot image in a memory coupled to the IC device, parsing, by the CPU, programs including =one or more operators and determining a count corresponding to each operator included in each program and an estimated program memory consumption of each operator, the count corresponding to each operator indicating a quantity of times the CPU detects each operator in each program, populating, by the CPU, the at least one boot image with common operators based on a program memory size limit of an hardware accelerator circuitry of the IC device and an estimated program memory consumption of each common operator, wherein the common operators are operators that are within a threshold count, and populating, by the CPU, the at least one boot image with non-common operators based on the program memory size limit of the hardware accelerator circuitry and an estimated program memory consumption of each non-common operator, wherein the non-common operators are operators that are not within the threshold count.

According to one or more examples, a system includes a hardware accelerator circuitry, a central processing unit (CPU) coupled to the hardware accelerator circuitry, and a memory coupled to the CPU and the hardware accelerator circuitry, wherein the CPU is configured to allocate at least one boot image in the memory, parse programs including one or more operators and determine a count corresponding to each operator included in each program and an estimated program memory consumption of each operator, the count corresponding to each operator indicating a quantity of times the CPU detects each operator in each program, populate the at least one boot image with common operators based on a program memory size limit of the hardware accelerator circuitry and an estimated program memory consumption of each common operator, wherein the common operators are operators that are within a threshold count, and populate the at least one boot image with non-common operators based on the program memory size limit of the hardware accelerator circuitry and an estimated program memory consumption of each non-common operator, wherein the non-common operators are operators that are not within the threshold count.

According to one or more examples, a central processing unit (CPU) includes a non-transitory computer readable medium configured to cause the CPU to perform a method including allocating at least one boot image in a memory coupled to an IC device, parsing programs including one or more operators and determining a count corresponding to each operator included in each program and an estimated program memory consumption of each operator, the count corresponding to each operator indicating a quantity of times the CPU detects each operator in each program, populating the at least one boot image with common operators based on a program memory size limit of an hardware accelerator circuitry of the IC device and an estimated program memory consumption of each common operator, wherein the common operators are operators that are within a threshold count, and populating the at least one boot image with non-common operators based on the program memory size limit of the hardware accelerator circuitry and an estimated program memory consumption of each non-common operator, wherein the non-common operators are operators that are not within the threshold count.

### BRIEF DESCRIPTION OF DRAWINGS

FIG. 1 illustrates an integrated circuit (IC) device with an hardware accelerator circuitry, according to an example

FIGS. 2A-2B illustrates a method for partitioning programs to be executed in a hardware accelerator circuitry, according to one or more examples.

FIGS. 3A-3G illustrate schematic diagrams of a programs (program code in the form of a series of operators) that are partitioned into a plurality of boot images stored in the memory using the method described in FIGS. 2A-2B according to one or more examples.

FIG. 3H illustrates a histogram generated by the CPU used to partition programs into a plurality of boot images used in the method described in FIGS. 2A-2B, according to one or more examples.

FIG. 4 illustrates a method for populating allocated boot images with the operators having counts that are not within a threshold count (non-common operators), according to one or more examples.

FIG. 5 illustrates a method for mapping boot images, according to one or more examples.

FIG. 6 illustrates a method 600 for mapping boot images, according to one or more examples.

FIG. 7 illustrates a method for partitioning a program to be executed in a hardware accelerator circuitry such as hardware accelerator circuitry 120, according to one or more examples.

FIGS. 8A-8J illustrate schematic diagrams of a program (program code in the form of a series of operators) that is partitioned into a plurality of boot images stored in the memory 135 using the method described in FIG. 7 according to one or more examples.

FIG. 9 illustrates a method for partitioning programs to be executed in a hardware accelerator circuitry, according to one or more examples.

### DETAILED DESCRIPTION

As noted above operators that are run an artificial intelligence (AI) architectures are typically implemented using kernels. The operators utilize both the compute unit of the AI engine and wrapper code that communicates with an external memory. Programs are typically loaded into a program memory of the AI engine which is typically limited by a memory capacity during execution. However, commonly used program operators such as a simple convolution kernel, or a sigmoid kernel quickly consume the entire memory capacity of the program memory. Thus, because the AI engine program memory can only support a few operators, programs quickly become unsalable on a per program basis.

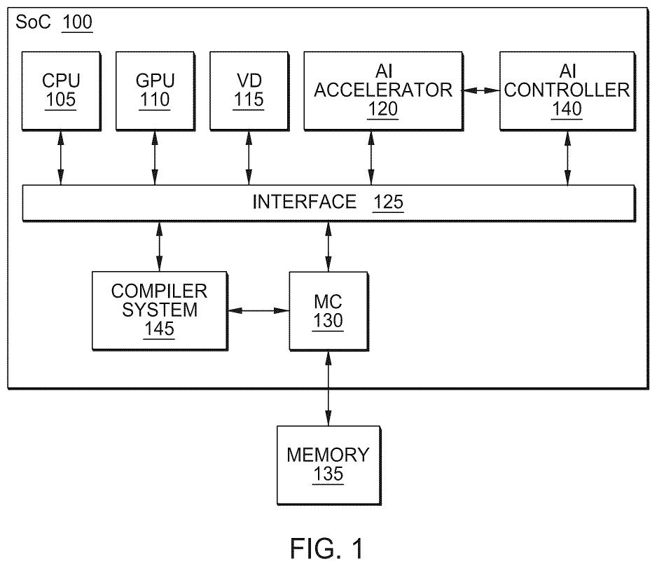

FIG. 1 illustrates an integrated circuit (IC) device 100. In one or more examples, the IC device 100 is a system on chip (SoC). The IC device 100 further includes with a hardware accelerator circuitry 120, according to an example. In one or more examples, the hardware accelerator circuitry 120 is an artificial intelligence (AI) accelerator circuitry. The IC device 100 can be a single integrated circuit (IC) or a single chip. In one embodiment, the IC device 100 includes a semiconductor substrate on which the illustrated components are formed using fabrication techniques.

The IC device 100 includes a central processing unit (CPU) 105, graphic processing unit (GPU) 110, virtual desktop (VD) 115, hardware accelerator circuitry 120 120, interface 125, a memory controller (MC) 130, and a compiler system 145. However, the IC device 100 is just one example of integrating a hardware accelerator circuitry 120 into a shared platform with the CPU 105. In other examples, an IC device may include fewer components than what is shown in FIG. 1. For example, the IC device may not include the VD 115 or an internal GPU 110. However, in other examples, the IC device may include additional components than the ones shown in FIG. 1. Thus, FIG. 1 is just one example of components that can be integrated into a IC device with the hardware accelerator circuitry 120.

The CPU 105 can represent any number of processors where each processor can include any number of cores. For example, the CPU 105 can include processors arranged in array, or the CPU 105 can include an array of cores. In one embodiment, the CPU 105 is an x86 processor that uses a corresponding complex instruction set. However, in other embodiments, the CPU 105 may be other types of CPUs such as an Advanced Reduced Set Instruction Computer (RSIC) Machine (ARM) processor.

The GPU 110 is an internal GPU 110 that performs accelerated computer graphics and image processing. The GPU 110 can include any number of different processing elements. In one embodiment, the GPU 110 can perform non-graphical tasks such as training an AI model or cryptocurrency mining.

The hardware accelerator circuitry 120 can include any hardware circuitry that is designed to perform AI tasks, such as inference. In one embodiment, the hardware accelerator circuitry 120 includes an array of DPEs that performs calculations that are part of an AI task. These calculations can include math operations or logic operations (e.g., bit shifts and the like).

The IC device 100 also includes one or more MCs 130 for controlling memory 135 (e.g., random access memory (RAM)). While the memory 135 is shown as being external to the IC device 100 (e.g., on a separate chip or chiplet), the MCs 130 could also control memory that is internal to the IC device 100.

The IC device 100 includes a compiler system 145. As will be described in more detail below, the compiler system 150 is used to compile and test boot images that are generated by the CPU 105 (or GPU 110) that are stored in the memory 135. In one or more examples, the compiler system 145 internal to the CPU 105 (or the GPU 110). In other examples, the compiler system 145 is external to the IC device 100.

The CPU 105, GPU 110, VD 115, hardware accelerator circuitry 120, and MC 130 are communicatively coupled using an interface 125. Put differently, the interface permits the different types of circuitry in the IC device 100 to communicate with each other. For example, the CPU 105 can use the interface 125 to instruct the hardware accelerator circuitry 120 to perform an AI task. The hardware accelerator circuitry 120 can use the interface 125 to retrieve data (e.g., input for the AI task) from the memory 135 via the MC 130, process the data to generate a result, store the result in the memory 135 using the interface 125, and then inform the CPU 105 that the AI task is complete using the interface 125.

In one embodiment, the interface 125 is a network operation center (NoC), but other types of interfaces such as internal buses are also possible.

For architectures such as hardware accelerator circuitry 120, programs to be executed by the hardware accelerator circuitry 120 typically include operators that are implemented with kernel code that utilizes compute units, and wrapper code that communicates with the memory 135. During execution, by the hardware accelerator circuitry 120, of a program, the program is loaded into a program memory within the hardware accelerator circuitry 120. However, the program memory has a program memory size limit that is typically not large enough to support each operator of a program. For example, a simple convolution operator consumes 5 KB of program memory and a sigmoid operator consumes 2 KB of program memory. Typically program memory size limits are from about 4 KB to about 64 KB, for example 16 KB. Due to the program memory size limit and the program memory consumption of operators within the program, only few operators are supported because the program memory consumption of operators easily exceeds the program memory size limit (capacity). Thus, it quickly becomes unscalable to deliver implementations on a per model or per customer basis.

Examples herein relate to dividing each of the operators into a plurality of boot images that have a same capacity as the program memory size limit. This guarantees the implementation is scalable because new operators can be easily added. Furthermore, boot images are then selected by the CPU 105 in a way that minimizes swapping between portioned boot images to execute a program to maintain the performance of the hardware accelerator circuitry 120.

In one or more examples, the boot images are allocated and populated by the CPU 105 (or the GPU 110). Stated otherwise, the plurality of boot images allocated and populated by the CPU 105 include potential programs that could be potentially called and executed by the hardware accelerator circuitry 120 so that the plurality of boot images are versatile and provide utility to multiple potential users of the same IC device.

In one or more examples, the plurality of boot images are programmable device images (PDIs). Any suitable quantity of boot images may be allocated in the memory 135. The boot images have a capacity equal to the program memory size limit (i.e., the capacity of program memory of the hardware accelerator circuitry 120). For example purposes only, the program memory capacity will be described herein as 16 KB. In other examples, the program memory of the hardware accelerator circuitry 120 is from about 4 KB and about 64 KB.

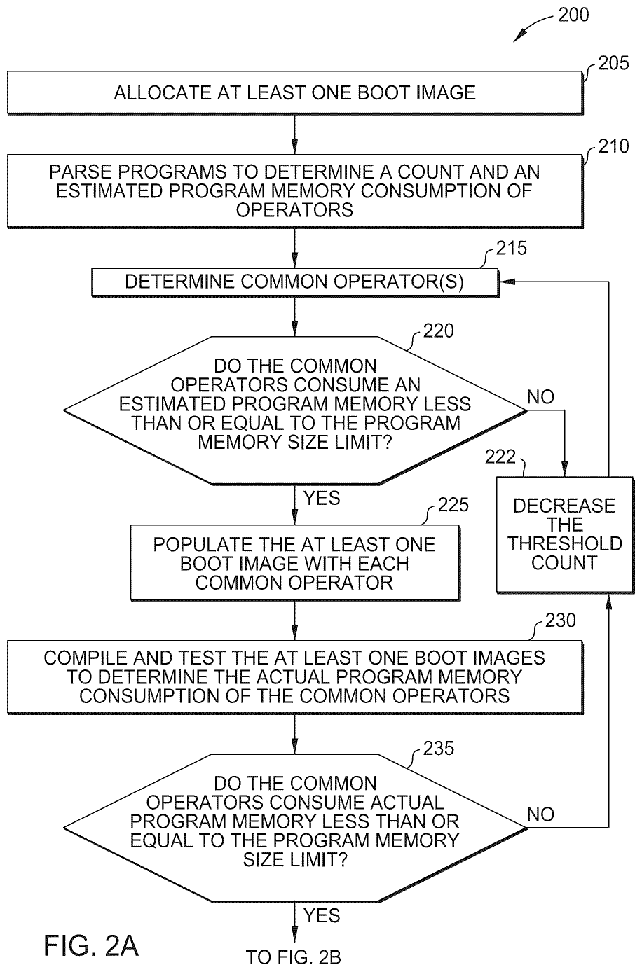

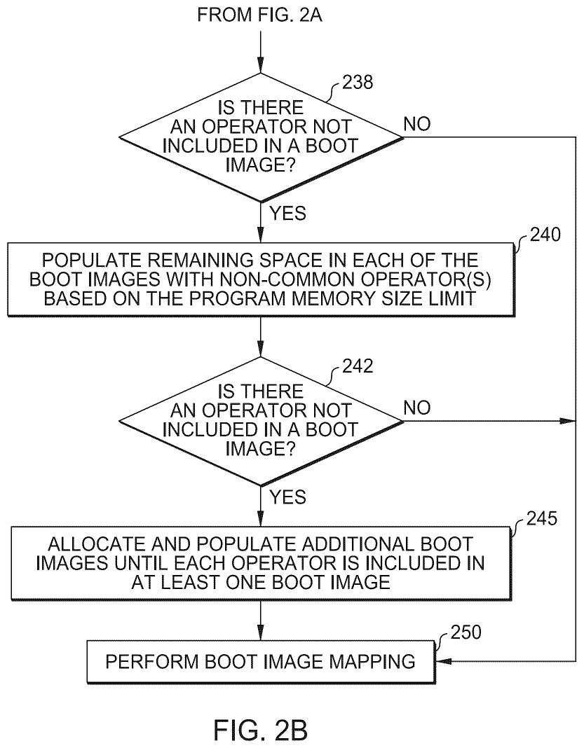

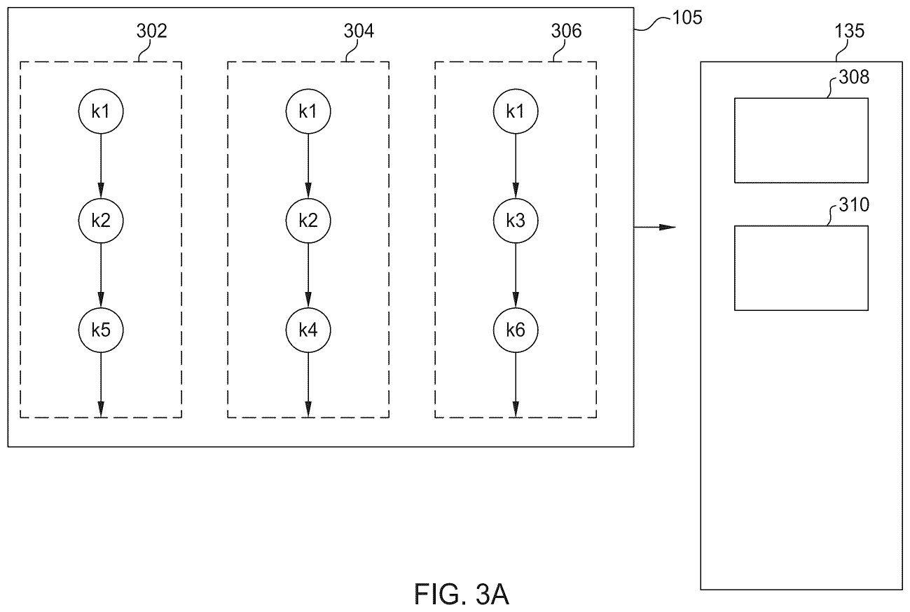

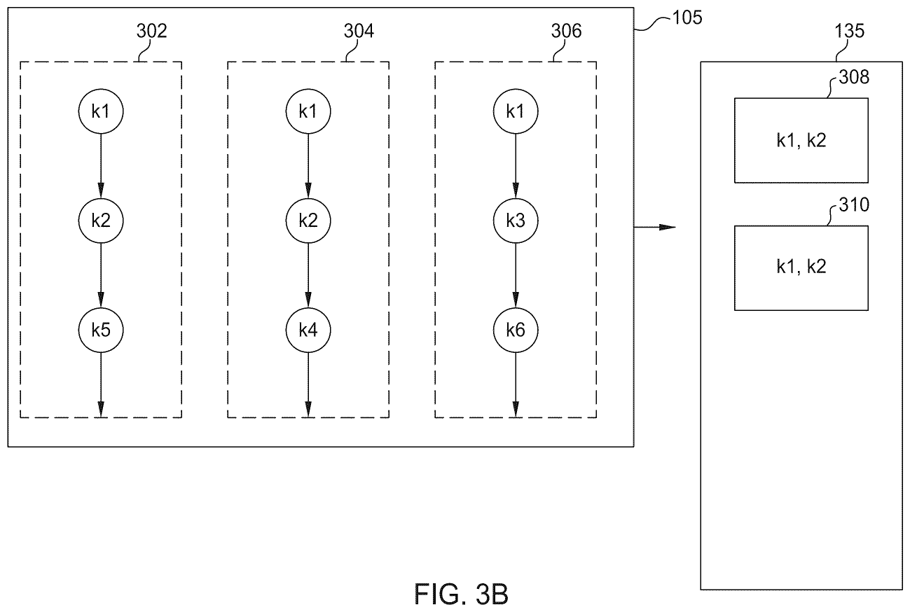

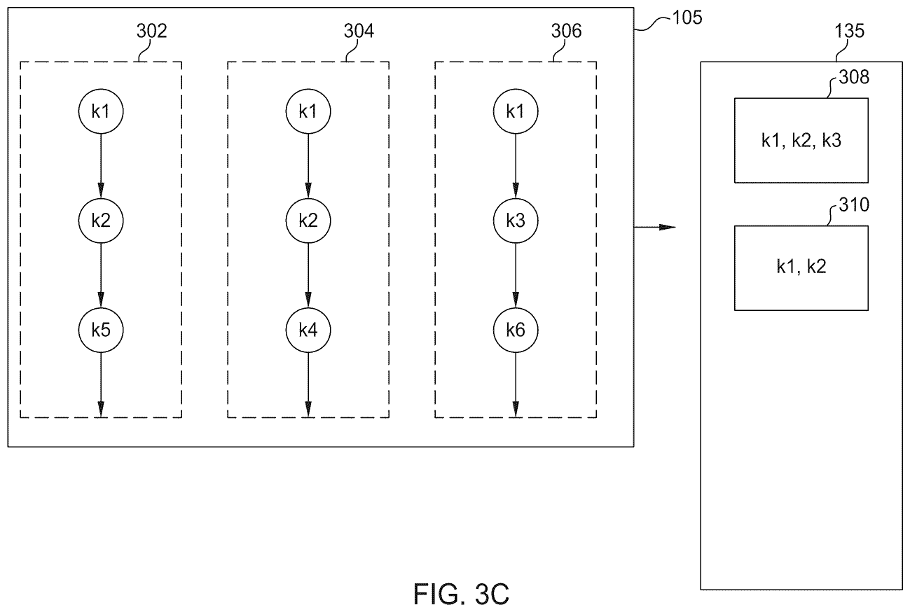

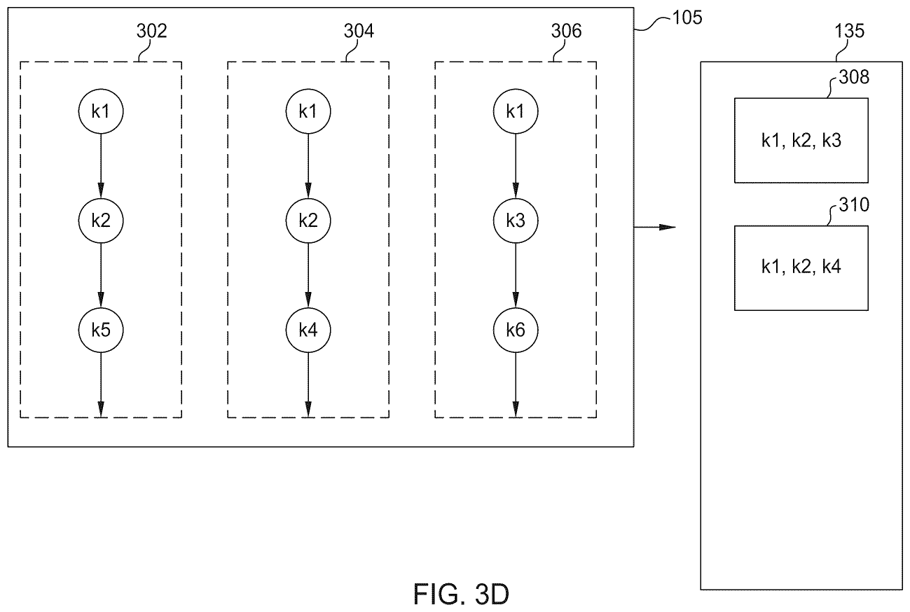

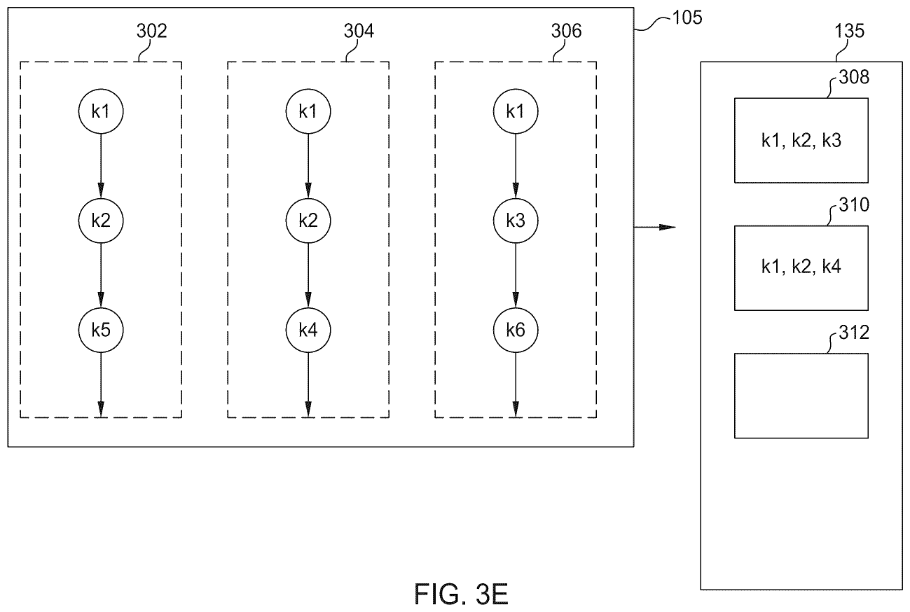

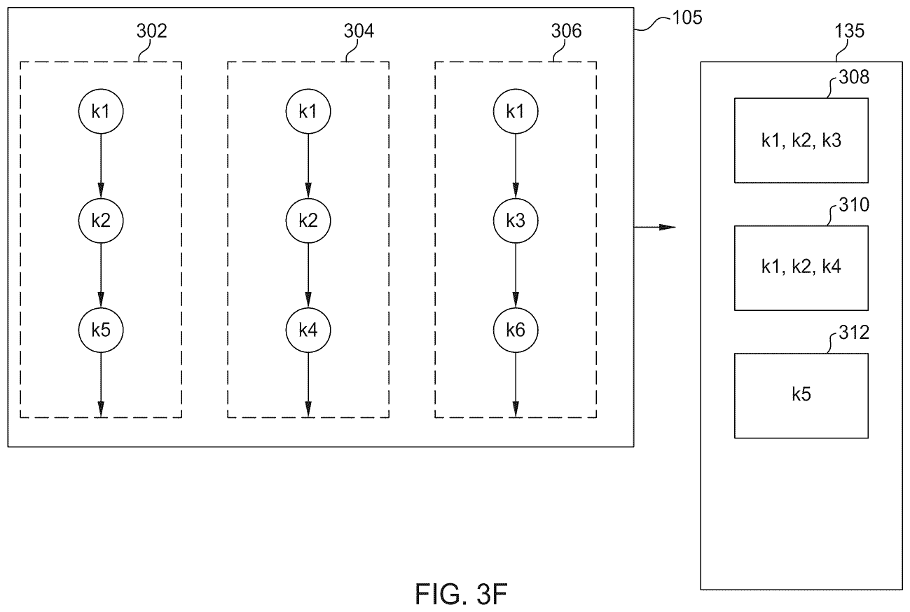

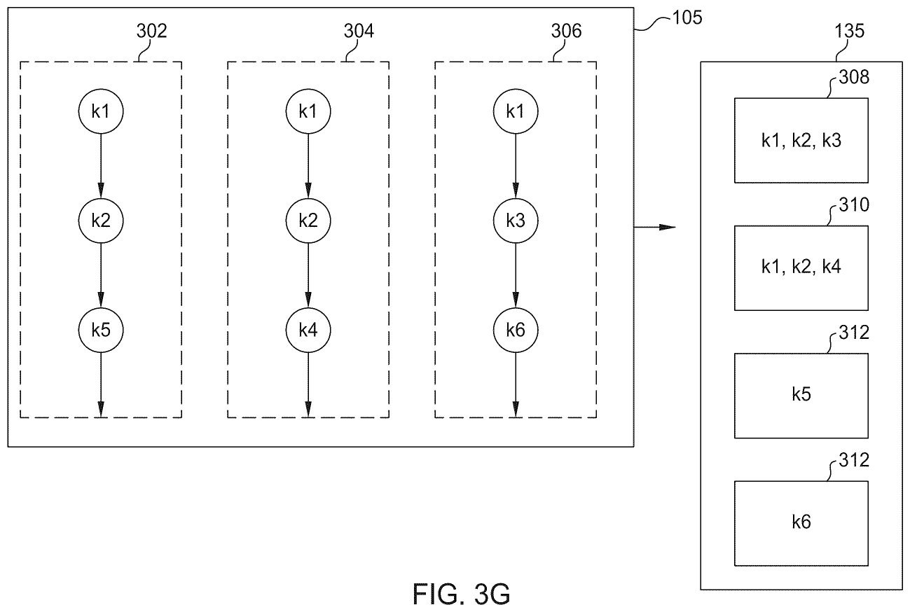

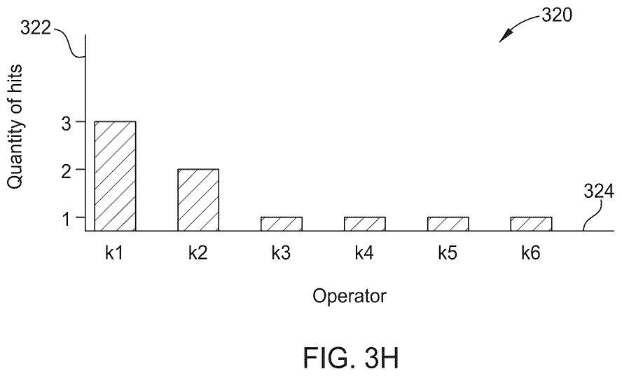

FIGS. 2A-2B illustrate a method 200 for partitioning programs to be executed in a hardware accelerator circuitry such as hardware accelerator circuitry 120, according to one or more examples. In one or more examples, the method 200 is performed by the CPU 105. FIGS. 3A-3G illustrate schematic diagrams of programs (program code in the form of a series of operators) that are partitioned into a plurality of boot images stored in the memory 135, according to one or more examples. FIG. 3H illustrates a histogram 320 generated by the CPU 105 used to partition programs into a plurality of boot images stored in the memory 135 used in the method 200 according to one or more examples.

At operation 205 of the method 200, and as illustrated in FIG. 3A, the CPU 105 allocates at least one boot image in the memory 135. As illustrated in FIGS. 3A, 3 different programs are provided to the CPU 105 by user(s). Each of the programs 302-306 include 3 operators. The program 302 includes the operators k1, k2, and k5. The program 304 includes the operators k1, k2, and k4. The program 306 includes the operators k1, k3, and k6. Although 3 operators and 3 programs are illustrated in FIG. 3A, this is for example purposes only and the quantity of operators and programs are not limited. In one or more examples, the operators include program code that is used to accomplish are tasks required to fully execute the program, such a convolution, sigmoid or the like. In one or more examples, the operators are performed in succession, or one or more operators are performed concurrently.

As also illustrated in FIG. 3A, the CPU 105 allocates boot images 308 and 310 within the memory 135. Although two boot images are allocated by the CPU 105, this is for example purposes only, and any suitable quantity of boot images may be allocated. In one or more examples, the at least one allocated boot image has a size (capacity) equal to the program memory size limit.

At operation 210 of the method 200, and as illustrated in FIG. 3A, the CPU 105 parses the programs stored in a memory that are provided to the CPU 105 by user(s) to determine an estimated program memory consumed by each operator and generates a count corresponding to each operator. The count corresponding to each operator indicates how many times the CPU 105 detects each program and is stored in a memory. For example, the operator k1 is included once in each of the programs 302-306, and therefore, the count for the operator k1 is 3. The count for the operator k2 is equal to 2 because operator k2 in included in the programs 302 and 304. The count for the operators k3-k6 is each 1. The operator k3 is included once in the program 306. The operator k4 is included once in the program 304. The operator k5 is included once in the program 302. The operator k6 is included once in the program 306.

As noted above, the operators consume different estimated amounts of program memory. In one or more examples, while the CPU 105 parses the programs, the CPU determines an estimated program memory consumption of each operator. For example purposes only, the estimated program memory consumption of the operator k1 is 10 KB, the estimated program memory consumption of the operator k2 is 5 KB, the estimated program memory consumption of the operator k3 is 1 KB, the estimated program memory consumption of the operator k4 is 1 KB, the estimated program memory consumption of the operator k5 is 5KB, and the estimated program memory consumption of the operator k6 is 12 KB.

In one or more examples, the CPU 105 generates a count for each operator by generating a histogram, such as histogram 320 illustrated in FIG. 3H. As illustrated in FIG. 3H the histogram 320 includes an axis 324 that represents each operator and an axis 322 that represents a quantity of hits of each operator within each of the programs 302-306 provided to the CPU 105. The quantity of hits of each operator is equal to the count corresponding to each operator. For example, the operator k1 has three hits on the histogram 320. The operator k2 has two hits on the histogram 320. The operators k4-k6 have one hit on the histogram 320. In one or more examples, the operators histogram is sorted by the quantity of hits of each operator in descending order (i.e., left-to right).

At operation 215 of the method 200, and as illustrated in FIGS. 3B and 3H, the CPU 105 determines common operators. In one or more examples, common operators are operators that are within a threshold count. In one or more examples, the threshold count is a desired quantity of operators in the histogram 320. In one or more examples, the threshold count is determined from left-to-right on the histogram 320. The threshold count ensures that the operator(s) with the highest count(s) are common operators. For example purposes only, the threshold count described herein is equal to 2. In other examples, the threshold count is greater than or less than 1.

Referring to the histogram 320, if the threshold count value is equal to 2, the first two operators (from left-to-right) on the histogram 320 are the common operators. The operator k1 is listed first on the histogram 320 and the operator k2 is listed second on the histogram 320. Thus, the operator k1 and the operator k2 are common operators. In another example if the threshold count were equal to 1, the operator k1 would be the only common operator.

At operation 220 of the method 200, and as illustrated in FIG. 3B, the CPU 105 determines whether the common operators consume an amount of estimated program memory that is less than or equal to the program memory size limit (i.e., the capacity of the at least one allocated boot image). If the CPU 105 determines that the sum of the estimated program memory consumed by the common operators is greater than the program memory size limit, the method proceeds to operation 222, the threshold count is decreased and the method 200 returns to operation 215. In one or more examples, the threshold count is decreased by 1 (or any other suitable value).

On the other hand, at operation 220, if the sum of the estimated program memory consumed by the common operators is less than or equal to the program memory size limit, the method 200 proceeds to operation 225, and each of the at least one allocated boot image(s) are populated by the common operators. Stated differently, the common operators are added to each of the least one boot images. Referring to FIGS. 3B and 3F, the sum of the estimated program memory consumed by the common operators k1 and k2 is equal to 15 KB (i.e., 10 KB plus 5 KB equals 15 KB), which is less than the program memory size limit of 16 KB. Thus, the boot image 308 and the boot image 310 are populated with the operators k1 and k2.

As understood by those with ordinary skill in the art, the program memory consumed by the operators k1-k6 are estimates. Therefore, at operation 230 the at least one allocated boot image is compiled and tested in the compiler system 145 to check the actual program memory consumption of each the at least one allocated boot images. For example, the boot images 308 and 310 that each include the operators k1 and k2 are compiled and tested to determine whether the boot images 308 and 310 are actually within the program memory size limit. The estimated program memory consumption of the operators k1 and k2 is updated in the memory 135 by the compiler system 145 to the actual program memory consumption based on the result of the compiling and testing.

At operation 235 of the method 200, the CPU 105 determines, based on the compiling and testing, whether the at least one allocated (an now populated) boot image exceeds the program memory size limit (based on the updated program memory consumption of the common operators (k1 and k2)). If the at least one allocated boot image is still within the program memory size limit, the method 200 proceeds to operation 238 and the CPU 105 determines whether there is an operator that is not included in a boot image.

On the other hand, if after compiling and testing, the at least one allocated boot image exceeds the program memory size limit, the method 200 proceeds to operation 222 and the CPU 105 decreases the threshold count in order to update the at least one allocated boot image. For example, if the actual sum of the program memory consumption of the operator k1 and the operator k2 exceeds 16 KB, the method 200 decreases the threshold count so the operator k2 is no longer considered a common operator (i.e., the threshold count equals 1). Stated otherwise, the at least one boot image is updated so that the operator k2 would be removed from the boot images 308 and 310 to comply with the program memory size limit.

In the example shown in FIGS. 3A-3G, for example purposes only, the actual program memory consumption of the common operators k1 and k2 is equal to the estimated program memory consumption, so the method 200 proceeds to operation 238.

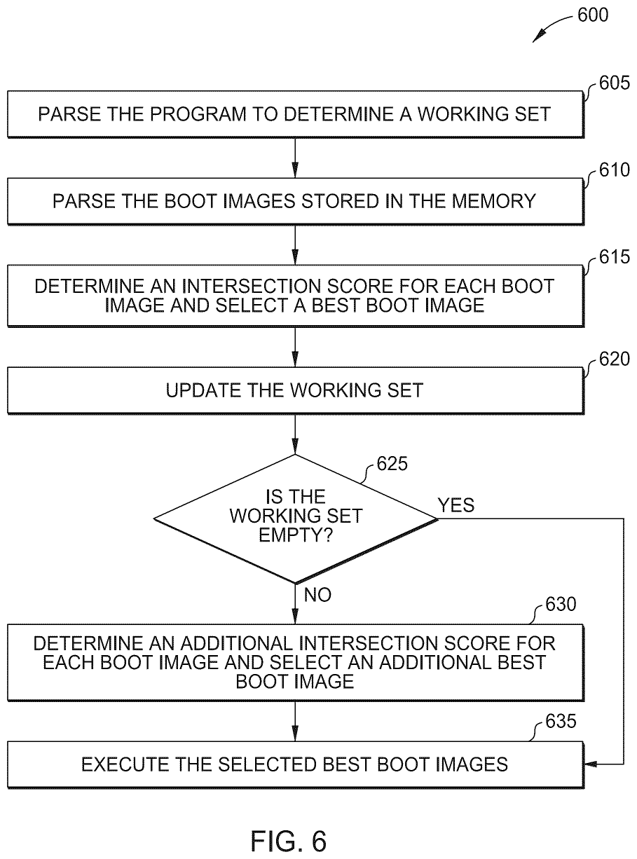

At operation 238, and as illustrated in FIG. 3C, if the CPU 105 determines that there is not an operator that is not included in a boot image, the method 200 proceeds to operation 250 and the CPU performs boot image mapping. This is described in more detail in FIG. 6.

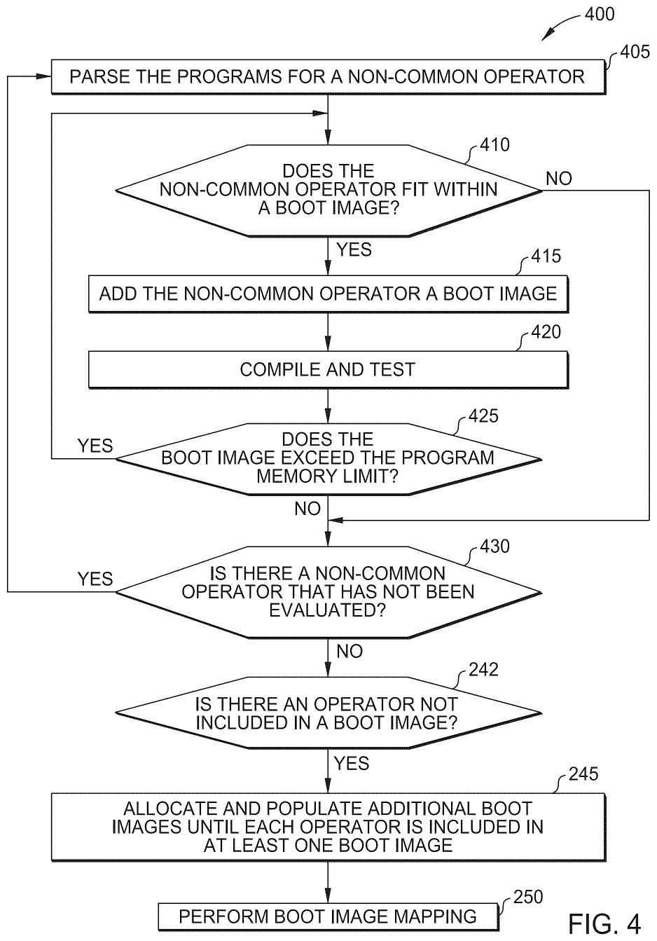

On the other hand, if the CPU 105 determines that there is an operator that is not included in a boot image, the method 200 proceeds to operation 240. Here, in the illustrated example, because the operators k3-k6 are not included in at least one boot image, the method proceeds to operation 240 and the boot images (i.e., boot images 308 and 310) are populated with non-common operators based on the program memory size limit. Operation 240 is described in detail in method 400 of FIG. 4.

FIG. 4 illustrates a method 400 for populating allocated boot images with the operators having counts that not within the threshold count (non-common operators), according to one or more examples. The method 400 corresponds to operation 240.

At operation 405 of the method 400, as illustrated in FIG. 3C, the CPU 105 parses the memory 135 to determine which operators are non-common operators. As noted above, the CPU 105 determines that the non-common operators are operators that are not within the threshold count.

At operation 410 of the method 400, as illustrated in FIG. 3C, the CPU 105 determines whether the non-common operator fits within the capacity of a boot image based on the estimated program memory consumption of the non-common operator and the program memory size limit. For example, the CPU 105 determines whether the operator k3 fits within the boot image 308 or the boot image 310. Stated differently, the CPU 105 determines whether the sum of the actual program memory consumed by the operators k1 and k2, and the estimated program memory consumed by the operator k3 is less or equal to than the program memory size limit. If the non-common operator (based on the estimated memory consumed) fits within the capacity the boot image (the program memory size limit), the method proceeds to operation 415 and the non common-operator is added to the boot image. The non-common operators are each added to a single boot image. On the other hand, if the non-common operator does not fit into the capacity of any of the allocated boot images, the non-common boot image is not added to a boot image, and the method 400 proceeds to operation 430. At the operation 430 the CPU 105 determines whether there is a non-common operator that has not been evaluated. If there is a non-common operator that has not been evaluated, the method 400 returns to operation 405.

Here, as illustrated in FIG. 3C, because, at operation 410, the operator k3 fits within the boot image 308 and the boot image 310, the method proceeds to operation 415 and k3 is added to the boot image 308 (or the boot image 310).

At operation 420 of the method 400, the boot image that the non-common operator is added to is compiled and tested by the compiler system 145 in the same manner described above, and the program memory consumed by the non-common operator is updated. For example, the boot image 308 is compiled and tested, and the program memory consumption of the operator k3 is updated. As noted above, for example purposes only, the estimated program memory consumption of the operator k3 is equal to the estimated program memory consumption of 1 KB.

At operation 425 of the method 400, the CPU 105 determines, based on the compiling and testing (the actual memory consumed by operator k3), if the actual program memory consumed by the boot image (i.e., the sum of the operators within the boot image) exceeds the program memory size limit. If the program memory consumed by the boot image is greater than the program memory size limit, the operator is removed from the boot image, the method 400 proceeds to operation 410, and the CPU 105 determines whether there is a boot image that can fit the operator based on its actual size. For example, if the operator k3 could not fit into boot image 308 based on its actual size, the CPU 105 will return to operation 410 and determine whether the operator k3 would fit into boot image 310 (or vice versa).

However, in this example, because the actual program memory consumption of operator k3 is equal to 1 KB, the operator k3 remains in the boot image 308, and the method 400 proceeds to operation 430 and the CPU 105 determines whether there is a non-common operator that has not been evaluated.

At operation 430 of the method 400, if there is not a non-common operator that has not been evaluated, the method 200 proceeds to operation 242 (FIG. 2B). At operation 242 of method 200 if the CPU 105 determines whether there is an operator that is not included in in a boot image. If there is an operator that is not included in a boot image, the method 400 proceeds to operation 245. If there is not an operator that are not included in a boot image the method 400 proceeds to operation 250.

On the other hand, at operation 430, if there is a non-common operator that has not been evaluated the method proceeds back to operation 405. In this example, as illustrated in FIG. 3C, because the non-common operators k4-k6 have not been evaluated, the method 400 returns to operation 405.

At operation 405 of the method 400, as illustrated in FIG. 3D, the CPU 105 determines the non-common operator k4.

At operation 410 of the method 400, as illustrated in FIG. 3D, the CPU 105 determines that the non-common operator k4 (based on the estimated memory consumption) fits into the boot image 310 because the estimated program memory consumption is 1 kB. The method 400 proceeds to operation 415 and adds the operator k4 into the boot image 310.

At operation 420 of the method 400, as illustrated in FIG. 3D, the boot image 310 is compiled and tested and the actual memory consumption of the operator k4 is updated.

At operation 425 of the method 400, as illustrated in FIG. 3D, for the same reasons described above, the CPU 105 determines that the boot image 310 does not exceed the program memory size limit so the method 400 proceeds to operation 430.

At operation 430 of the method 400, as illustrated in FIG. 3D, the CPU 105 determines there is still a non-common operator (i.e., the operators k5 and k6) that has not been evaluated so the method 400 returns to operation 405.

For operator k5, as illustrated in FIG. 3D, the CPU 105 will determine that the operator k5 does not fit into boot images 308 and 310 because both allocated boot images are now at capacity. Therefore, the method 400 will skip from operation 410 to operation 430 and then return to operation 405 to evaluate the operator k6.

For the operator k6, as illustrated in FIG. 3D, the CPU 105 will also determine that the operator k6 does not fit into the boot images 308 and 310. Therefore, the method 400 will skip from operation 410 to operation 430, and then proceed to operation 242 because at operation 430 the CPU 105 will determine there is not a non-common operator that has not been evaluated.

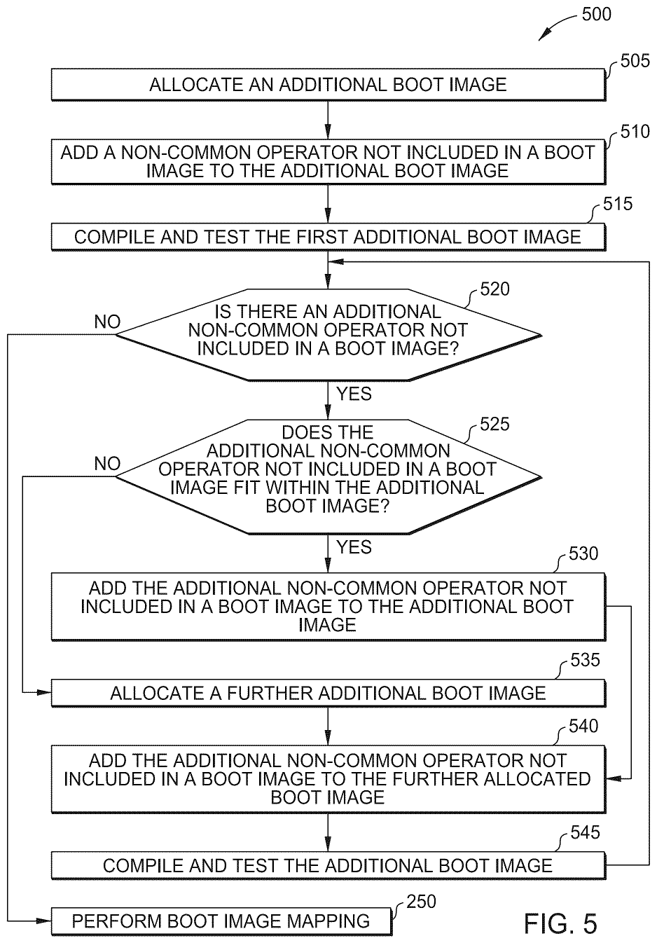

Referring back to FIG. 2B, at operation 245 the CPU 105 allocates and populates additional boot image(s) until each operator is included in at least one boot image. Operation 245 is described in more detail in FIGS. 3E-3G and 5.

FIG. 5 illustrates a method 500 for allocating and populating additional boot image(s) until each operator is included in at least one boot image, according to one or more examples. In one or more examples, method 500 corresponds to operation 245 of the method 200.

At operation 505 of the method 500, as illustrated in FIG. 3E, the CPU 105 allocates an additional boot image. For example, the CPU 105 allocates an additional boot image 312.

At operation 510 of the method 500, as illustrated in FIG. 3F, a non-common operator not included in a boot image is added to the additional boot image. For example, the operator k5 is added to the additional boot image 312.

At operation 515 of the method 500, as illustrated in FIG. 3F, the additional boot image (i.e., additional boot image 312) is compiled and tested by the compiler system 145 and the actual memory capacity of the first non-common operator is determined.

At operation 520 of the method 500, the CPU 105 determines whether there is an additional non-common operator that is not included in a boot image. In one or more examples, the CPU 105 determines whether there is an additional non-common operator that is not included in a boot image by parsing each of the boot images stored in the memory 135, and determining whether there is an operator stored in the programs 302-306 that is not stored in at least one boot images. If the CPU 105 determines that there is not an additional non-common operator that is not included in a boot image, the method 500 proceeds to operation 250. If the CPU 105 determines that there is an additional non-common operator that is not included in a boot image, the method 500 proceeds to operation 525 and the CPU 105 determines whether the additional non-common operator not included in a boot image fits within an additionally allocated boot image. For example, at operation 520, as illustrated in FIG. 3G, the CPU 105 determines that the operator k6 is not included in any boot images. Therefore, the CPU 105 proceeds to the operation 525 and determines whether the operator k6 fits within the additional boot image 312.

At operation 525 of the method 500, as illustrated in FIG. 3G, if the CPU 105 determines that the additional non-common operator not included in a boot image operator fits into one of the additional allocated boot images (e.g., additional boot image 312), the method proceeds to operations 530, 545, and 520. In particular the additional non-common operator not included in a boot image is added to the additional boot image (operation 530), the additional boot image is compiled and tested (and updated if necessary) in the same manner described above (operation 545) and the method 500 returns to operation 520 and the CPU 105 determines whether there is a further non-common operator that is not included in a boot image.

On the other hand, if the CPU 105 determines that the additional non-common operator not included in a boot image does not fit into one of the additional allocated boot images, the method 500 proceeds to operations 535, 540, 545, and 520. In particular, the CPU 105 allocates a further additional boot image (operation 535), adds the additional non-common operator not included in a boot image to the further additional boot image (operation 540). Then the compiler system 145 complies and tests the further additional boot image (operation 545), and the method 500 returns to operation 520 and the CPU 105 determines whether there is an additional non-common operator that is not included in a boot image.

For example, referring back to FIG. 3G, the operator k5 consumes 5 KB of program memory and operator k6 consumes 12 KB of program memory. Therefore, at operation 525, the CPU 105 determines that the operator k6 does not fit into the additional boot image 312. Therefore, the CPU 105 allocates a further additional boot image 314 (operation 535) and adds the operator k6 to the further additional boot image 314 (operation 540). Then the compiler system 145 compiles and tests the further additional boot image 314 (operation 545). After the compiling and testing of the further additional boot image, the CPU 105 updates the program memory consumed by the operator k6. Then the method 500 returns to operation 520.

On the other hand, if the estimated program memory consumed by the operator k6 is less than or equal to 11 KB, at operation 525 the CPU 105 would determine that the operator k6 fits within the additional boot image 314. Therefore, the CPU 105 would proceed to operation 530 and add the operator k6 to the additional boot image 314. Then at operation 545, the additional boot image 314 is compiled and tested and the actual program memory consumption of the operator k6 is updated. In one or more examples, if the actual program memory consumed by the operator k6 (the additional non-common operator that was just added to the additional boot image) plus the actual program memory consumed by the operator k5 (i.e., the actual program memory consumed by the operators already within the additional allocated boot image) is greater than the program memory size limit, the operator k6 would be removed from the additional boot image 314 and added to an already additional allocated boot image, or be added to a newly allocated boot image based on the actual memory consumption of the operator k6.

Based on a determination that there are not any non-common operators that are not included in a boot image, the method 500 (and the method 200) proceeds to operation 250.

The operation is described in greater detail with regard to the method 600 for mapping boot images illustrated by the flowchart of FIG. 6, according to one or more examples. In one or more examples, because the operators of each program are partitioned into boot images offline, when the programs are actually executed the CPU 105 selects the boot images that are executed. In one or more examples, the CPU 105, during operation 250 (and method 600) selects a combination of boot images that include all the operators required to run a specific program (i.e., cover the entire program). The CPU 105 selects a combination of boot images that covers the entire program and includes the least amount of boot images to reduce switching between boot images by computing the intersections (intersection scorese) between boot images and a working set. Advantageously this allows for the program to be fully covered (fully executed) to maintain the performance of the hardware accelerator circuitry 120. For example purposes only, method 600 is described as if the program 302 is be executed by the hardware accelerator circuitry 120.

At operation 605 of the method 600, the CPU 105 parses the program called by the hardware accelerator circuitry 120 and generates a working set (i.e., the CPU parses a to be executed program). The working set is defined herein as each of the operators required to run a program. By parsing the program, the CPU 105 determines which operators are executed during the program. For example, referring to FIG. 3G, the program called (to be executed) by the hardware accelerator circuitry 120 is program 302 and therefore, the working set (required operators) includes the operator k1, the operator k2, and the operator k5.

At operation 610, the CPU 105 parses the boot images stored in the memory 135 to determine which operators are stored in which boot image. For example, referring to FIG. 3D, the CPU 105 parses the memory 135 to determine which operators are stored within the boot image 308, the boot image 310, the additional boot image 312, and the further additional boot image 314.

At operation 615 of the method 600, the CPU 105 determines intersection scores for each boot image and selects a best boot image based on the working set. The intersection score for each boot image is determined iteratively. The intersection score for a boot image is equal to the quantity of operators that are included in both the boot image and the working set divided by the quantity of operators in the working set. The boot image with the highest intersection score is flagged as the best boot image as the intersection score of each boot image is determined iteratively. In one or more examples, after calculating a current intersection score for a current boot image, the current intersection score is compared to an intersection score of a boot image that is flagged as the best boot image. If the current intersection score is greater than the intersection score of the boot image flagged as the best boot image, the current boot image is flagged as the best boot image. In other examples, if the current intersection score is greater than or equal to the intersection score of the boot image flagged as the best boot image, the current boot image is flagged as the best boot image.

For example, referring back to FIG. 3G the CPU 105 will first determine the intersection score for the boot image 308. The boot image 308 includes the operator k1 and the operator k2, and therefore, includes 2 out of 3 operators of the working set. The boot image 308 has an intersection score of approximately 66%. The boot image 308 is then flagged as the boot image with the highest intersection score because the boot image 308 is the first boot image assigned with an intersection score.

Next, the CPU 105 will determine the intersection score for the boot image 310. The boot image 310 includes the operator k1 and the operator k2, and therefore, includes 2 out of 3 operators of the working set. The boot image 310 has an intersection score of approximately 66%. Here, because the intersection score of the boot image 310 does not exceed the intersection score of the boot image 308, the boot image 308 remains flagged as the best boot image. In other examples, because the intersection score of the boot image 310 is equal to the intersection score of the boot image 308, the boot image 310 is flagged as the best boot image.

Next, the CPU 105 will determine the intersection score for the additional boot image 312. The additional boot image 312 includes the operator k5, and therefore includes 1 out of 3 operators of the working set. The additional boot image 312 has an intersection score of approximately 33%. Here, because the intersection score of the additional boot image 312 does not exceed the intersection score of the boot image 308 (or boot image 310), the boot image 308 (or the boot image 310) remains flagged as the best boot image.

Last, the CPU 105 will determine the intersection score for the further additional boot image 314. The further additional boot image 314 includes the operator k6, and therefore includes 0 out of 3 operators of the working set. The further boot image 314 has an intersection score of approximately 0%. Here, because the intersection score of the further additional boot image 314 does not exceed the intersection score of the boot image 308 (or boot image 310), the boot image 308 (or the boot image 310) remains flagged as the best boot image. After determining an intersection score for each boot image the best boot image 308 is selected as the first best boot image.

On the other hand, if each of the boot images has an intersection score of 0%, the CPU 105 will send a fail signal to the hardware accelerator circuitry 120 and the program cannot be executed.

At operation 620, the CPU 105 updates the working set. In one or more examples, updating the working set includes removing the operators from the working set that are included in the selected best boot image. For example, referring back to FIG. 3G, the working set would be updated to only include the operator k5 because the operator k1 and the operator k2 are included in the first best boot image, boot image 308 (or boot image 310).

At operation 625, the CPU 105 determines whether the working set is empty. If the working set is not empty, the method 600 proceeds to operation 630 and the CPU 105 determines additional intersection scores for each boot image and determines an additional best boot image based on the working set.

At operation 630, the CPU 105 determines an additional intersection score for each boot image and determines an additional best boot image based on the working set in the same manner described in operation 615. For example, because the working set includes operator k5, the additional boot image 312 will have an additional intersection score of 100% while the other boot images have an additional intersection score of 0%. Therefore, the CPU 105 will select the additional boot image 312 as a best boot image, and the method 600 will return to operation 620.

On the other hand, if the working set is empty, the selected boot images are executed in the hardware accelerator circuitry 120. For example, after selecting the additional boot image 312 as an additional best boot image and returning to operation 620, the operator k5 is removed and the working set is now empty. Therefore, the method 600 proceeds to operation 635 and the boot image 308 (or the boot image 310) and the additional boot image are executed in the hardware accelerator circuitry 120.

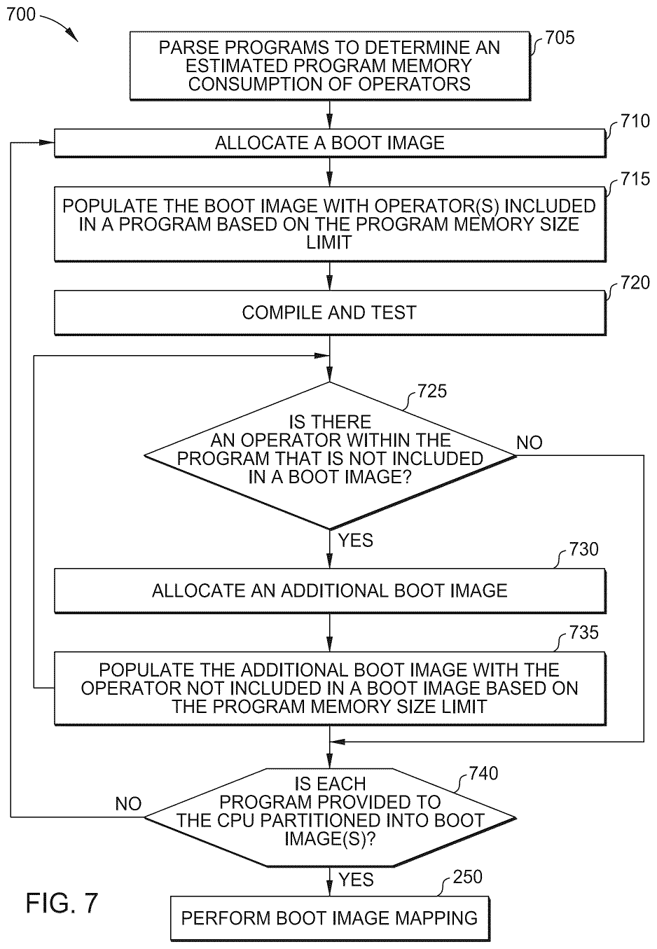

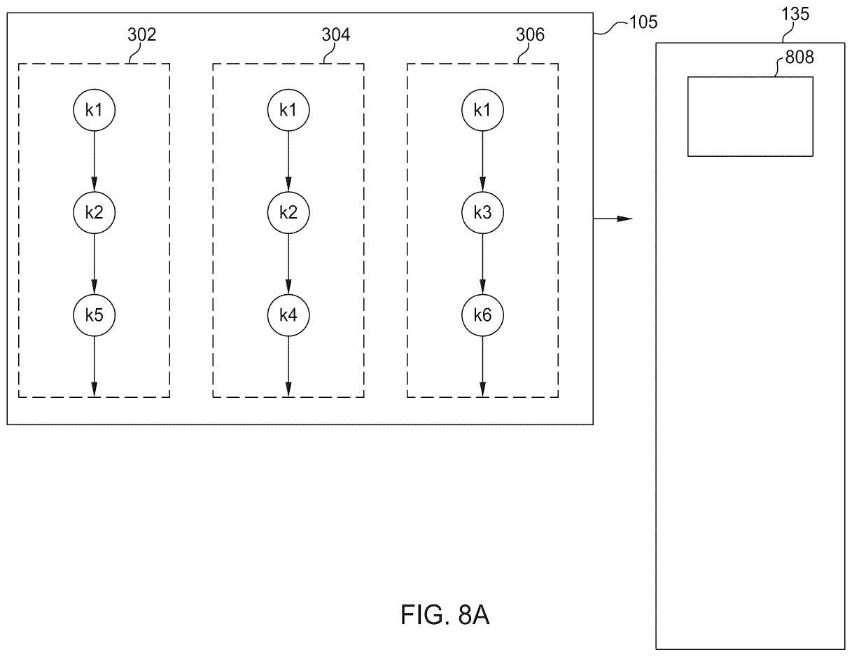

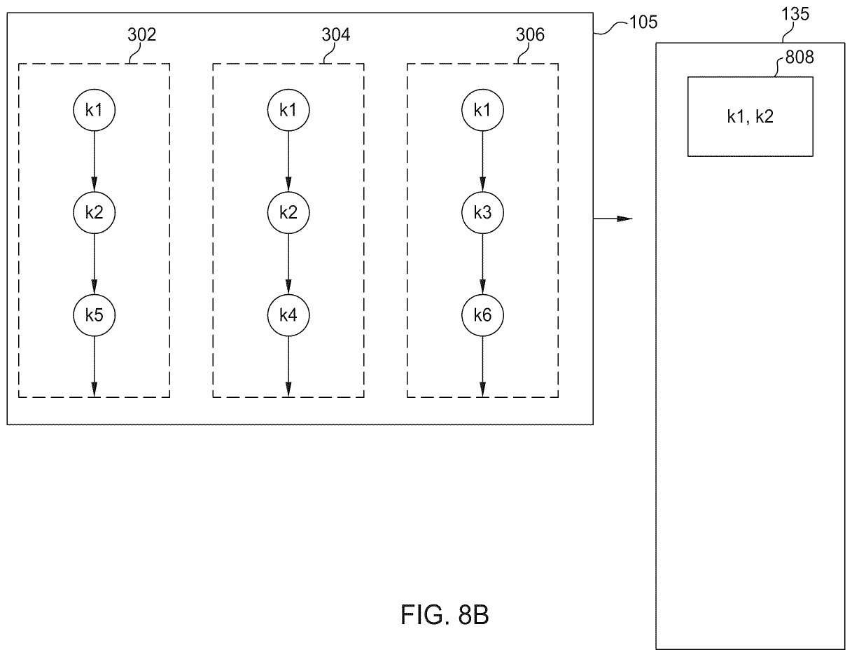

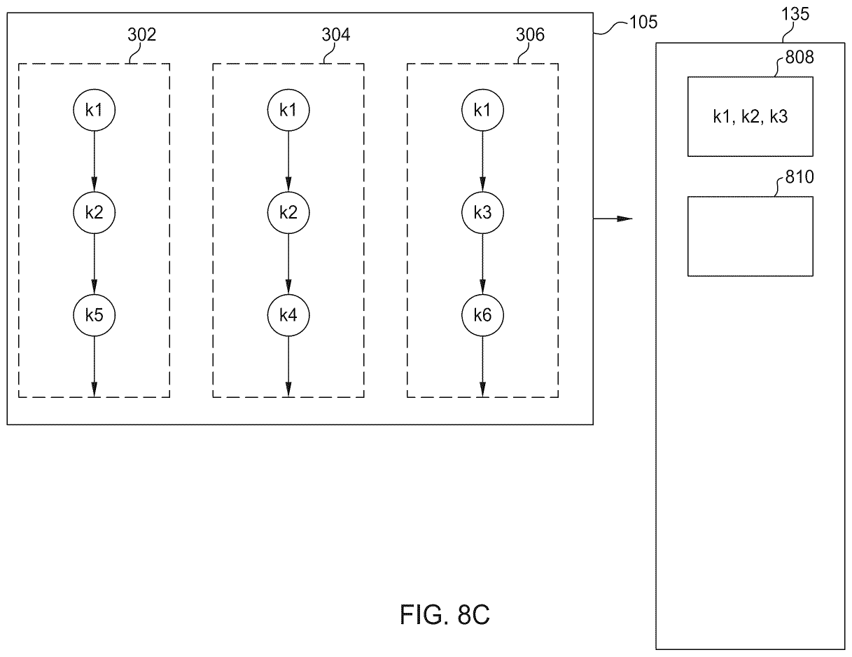

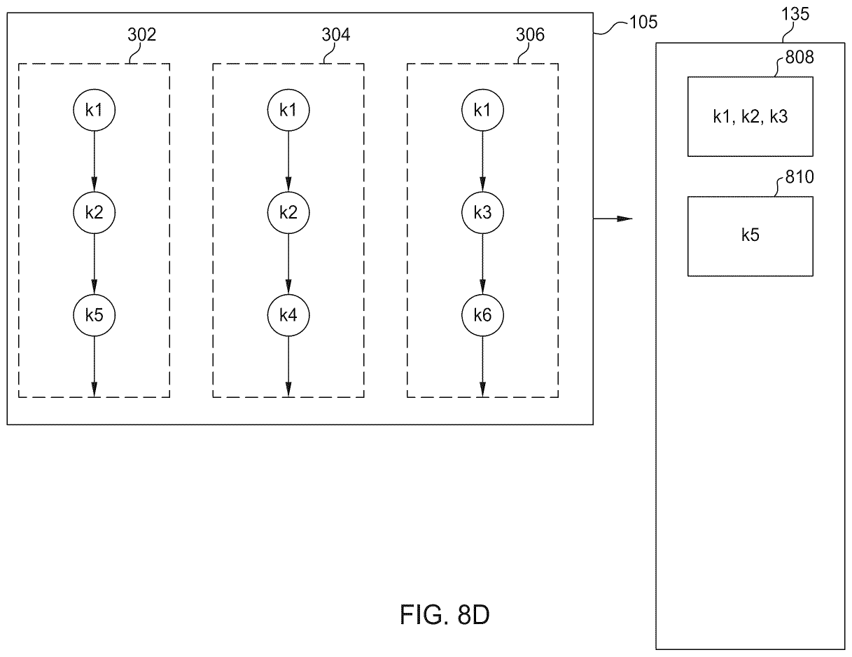

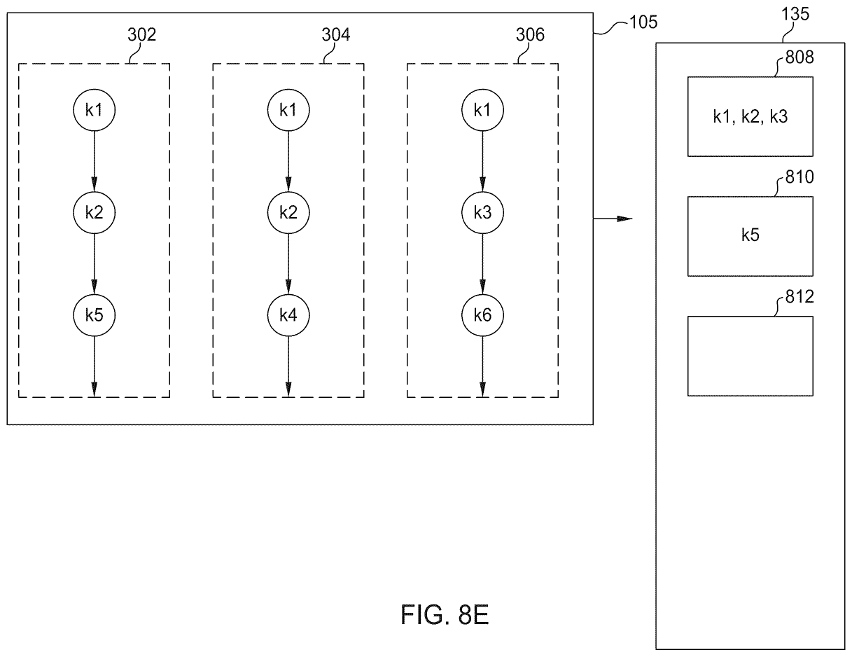

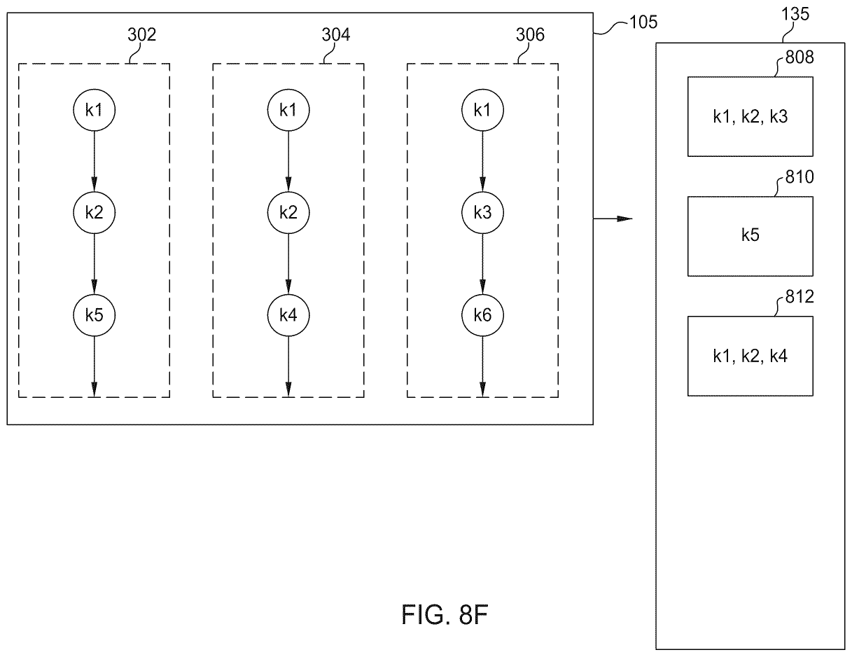

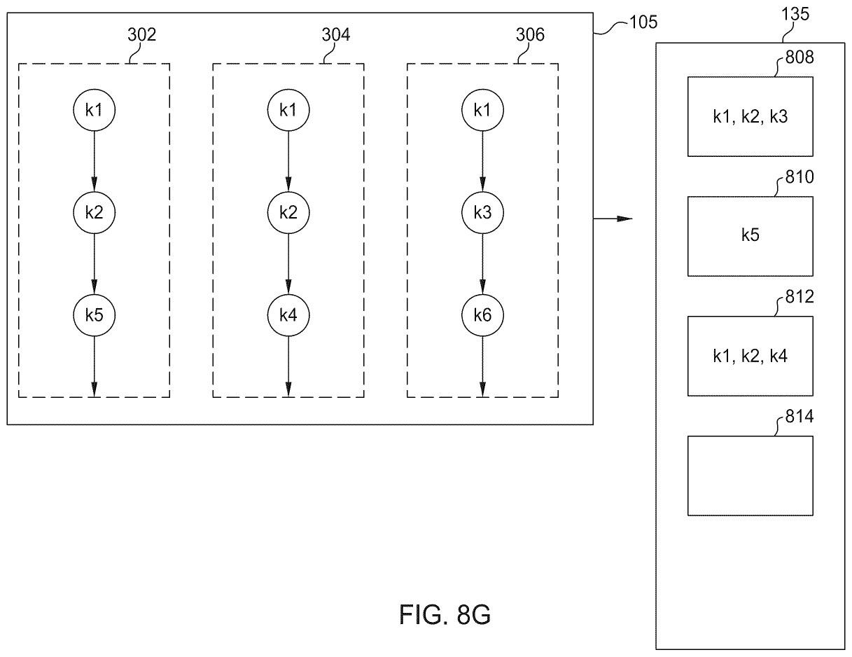

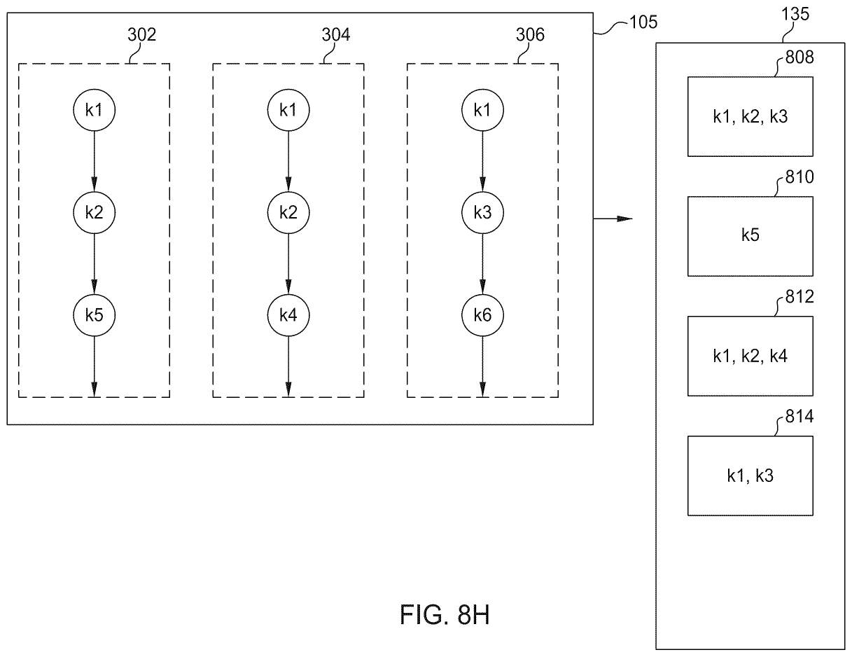

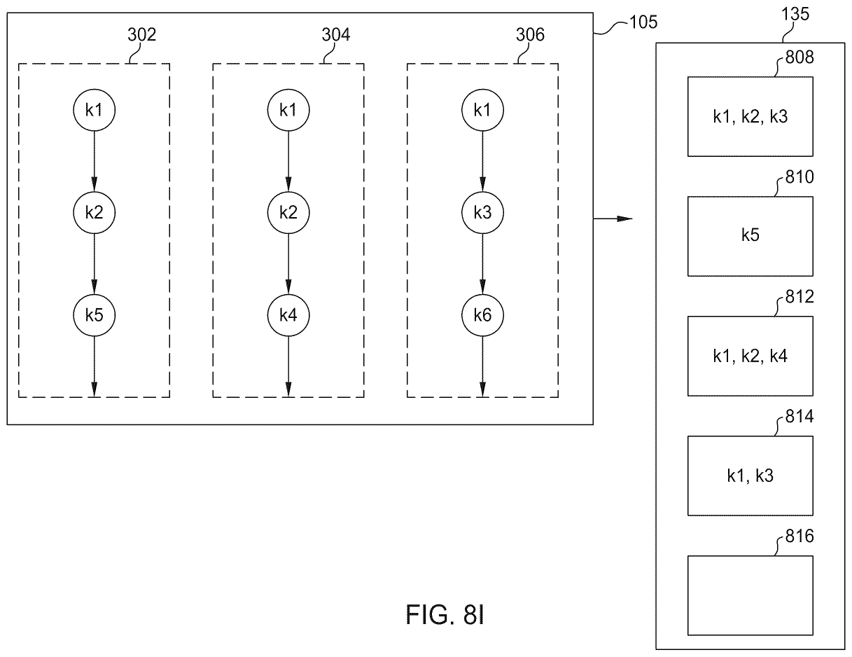

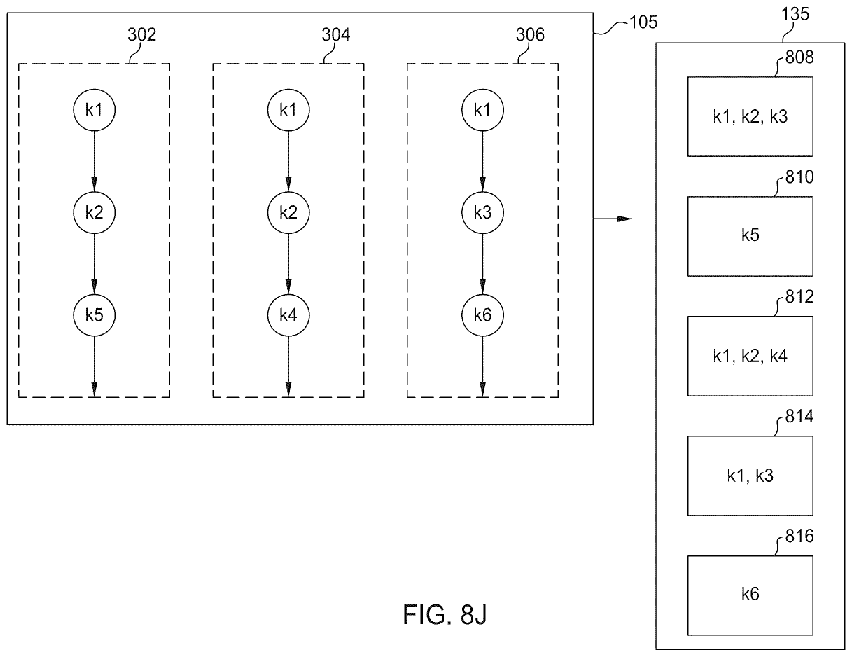

In one or more example, operators of a specific program provided by a customer can be petitioned into custom boot images. FIG. 7 illustrates a method 700 for partitioning a program to be executed in an hardware accelerator circuitry such as hardware accelerator circuitry 120, according to one or more examples. FIGS. 8A-8E illustrate schematic diagrams of a program (program code in the form of a series of operators) that is partitioned into a plurality of boot images stored in the memory 135 using the method 700 described in FIG. 7 according to one or more examples. At operation 705 of the method 700, as illustrated in FIG. 8A, the CPU 105 parses the programs that are provided to the CPU 105 to determine an estimated program memory consumed by each operator. Operation 705 is performed in the same manner as operation 205 of the method 200.

At operation 710 of the method 700, as illustrated in FIG. 8A, the CPU 105 allocates a boot image. For example, the CPU allocates the boot image 808. Although only one boot image is allocated, this is for example purposes only, and any quantity of boot images may be allocated (i.e., at least one boot image is allocated).

At operation 715, of the method 700, as illustrated in FIG. 8B, the boot image is populated with one or more operators included in a program based on the program memory size limit. When generating custom boot images (i.e., method 700) each of the programs provided to the CPU 105 are partitioned into boot images individually based on the program memory size limit. For example, the program 302 is partitioned first. Although the method 700 is described as partitioning the programs sequentially, the programs may be partitioned in any suitable order.

When partitioning each program into boot images, a boot image is first allocated and then filled with operators in the program until the boot image reaches capacity. Referring to FIG. 8B, the operator k1 is first added to the boot image 808. The operator k1 has an estimated program memory consumption of 10 KB, and therefore fits into the boot image 808. Next, the operator k2 is added to the boot image 808. Because the operator k2 has an estimated program memory consumption of 5 KB, the operator k2 can be added to the boot image 808. Next, the CPU 105 checks to add the operator k5 to the boot image 808. Because the operator k5 has an estimated program memory of 5 KB, the operator k5 cannot be added to the boot image 808. Thus, the method 700 proceeds to operation 720 the boot image 808 is compiled and tested (and updated if necessary).

At operation 725 of the method 700, as illustrated in FIG. 8C, the CPU 105 determines whether there is an operator within the program that is not included in a boot image. If the CPU 105 determines that there is an operator within the program that is not included in a boot image, the method proceeds to operation 730 and the CPU 105 allocates an additional boot image. For example, as illustrated in FIG. 8C, the operator k5 is not included in an operator, so the CPU 105 allocates a boot image 810 and the method proceeds to operation 735. On the other hand, if the CPU 105 determines that each operator within the program is included in a boot image, the method 700 proceeds to operation 740 and the CPU 105 determines whether each program provided to the CPU 105 is partitioned into boot image(s). Operation 740 is described in more detail below.

At operation 735 of the method 700, as illustrated in FIG. 8D, the additional boot image is populated with an operator of the program that has not been included in a boot image based on the program memory size limit and the method returns to operation 720, and the boot image 808 is compiled and tested. Here, the boot image 810 is populated with the operator k5 and is compiled and tested. Then, the method 700 proceeds to operation 725.

As noted above, at operation 725 of the method 700, if the CPU 105 determines that all operators within the program are included in a boot image, the method proceeds to operation 740. For example, after the operator k5 is added to the boot image 810, at operation 725, the CPU 105 determines that all operators included in the program 302 are included in a boot image and the method 700 proceeds to operation 740.

At operation 740 of the method 700 the CPU 105 determines whether each program provided to the CPU 105 has been partitioned into boot image(s). If each program provided to the CPU 105 have partitioned into boot image(s), the method 700 returns to operation 710 and the CPU 105 allocates a boot image. As illustrated in FIG. 8E, because the programs 304 and 306 are not partitioned into boot image(s), the method returns to operation 710 and allocates a boot image 812 to begin partitioning program 304 (or program 306) into boot image(s).

On the other hand if the CPU 105 determines at operation 740 that all programs have been partitioned into boot images, the method proceeds to operation 250 and the boot image(s) are mapped.

At operation 715, in the same manner described above, the boot image 812 is populated with one or more operators included in the program 304 based on the program memory size limit. As illustrated in FIG. 8F, the boot image 812 is populated with the operators k1, k2, and k4 because the sum of the program memory consumed by the operators k1, k2, and k4 is equal to 16 KB. The method 700 then proceeds to operation 720 and the boot image 812 is compiled and tested.

After compiling and testing the boot image 812, the method 700 proceeds to operation 725. Here, because each operator of the program 304 is included in a boot image, the method proceeds to operation 740.

At operation 740 of the method 700, the CPU 105 determines that the program 306 has not been partitioned into boot images. Therefore, the method 700 returns to operation 710.

At operation 710 of the method 700, as illustrated in FIG. 8G, the CPU 105 allocations a boot image 814, to begin partitioning program 306 into boot image(s).

At operation 715 of the method 700, the CPU 105 populates the boot image 814 with the operators included in the program 306 based on the program memory size limit. As illustrated in FIG. 8H, the CPU 105 is able to populate the boot image 814 with the operator k1 and the operator k3. The CPU 105 is not able to include the operator k6 in the boot image 814 because it would cause the boot image 814 to exceed the program memory size limit. The method 700 then proceeds to operation 720 and the boot image 814 is compiled and tested. Then the method 700 proceeds to operation 725.

At operation 725 of the method 700, the CPU 105 determines that there is an operator (the operator k6) that is not included in a boot image. Therefore, the method 700 proceeds to operation 730.

At operation 730 of the method 700, the CPU 105 allocates an additional boot image. As illustrated in FIG. 8I, here the CPU 105 allocates boot image 816, and then proceeds to operation 735.

At operation 735 of the method 700, the CPU 105 populates the additional boot image with an operator included in the program that is not included in a boot image. As illustrated in FIG. 8J, here, the boot image 816 is populated with the operator k6. The method 700 returns to operation 720, and the boot image 816 is compiled and tested. Then the method proceeds to operation 725.

At operation 725 of the method 700, the CPU 105 determines that each operator of the program is included in a boot image. Here, each of the operators (k1, k3, and k6) included in the program 306 are included in a boot image. Therefore, the method proceeds to operation 740 and the CPU 105 determines whether each program provided to the CPU 105 is partitioned into boot images. Here, each of the programs (programs 302-306) are partitioned into boot images. Therefore, the method 700 proceeds to operation 250, and the boot images are mapped.

As noted above, examples herein relate to dividing each of the operators included in a plurality of programs to be executed in the hardware accelerator circuitry 120 into boot images that have a same capacity as the program memory size limit of the hardware accelerator circuitry 120. In order to execute a program in the hardware accelerator circuitry 120, the boot images including each operator included in the to be executed program are provided to the hardware accelerator circuitry 120 Advantageously, this allows programs that include operators that consume more program memory than the program memory size limit of the hardware accelerator circuitry 120 to still be executed by the hardware accelerator circuitry 120. Furthermore, by dividing the program operators into boot images allows for the implementation of the programs to be scalable by because new operators can be easily added without violating the program memory size limit of the hardware accelerator circuitry 120. Furthermore, by performing boot image mapping, the boot images that are executed in the hardware accelerator circuitry 120 are selected by the CPU 105 in a way that minimizes swapping between portioned boot images to maintain the performance of the hardware accelerator circuitry 120. Stated differently, when executing a program the CPU provided the least amount of boot images as possible to the hardware accelerator circuitry 120 while ensuring each operator included in the program is executed.

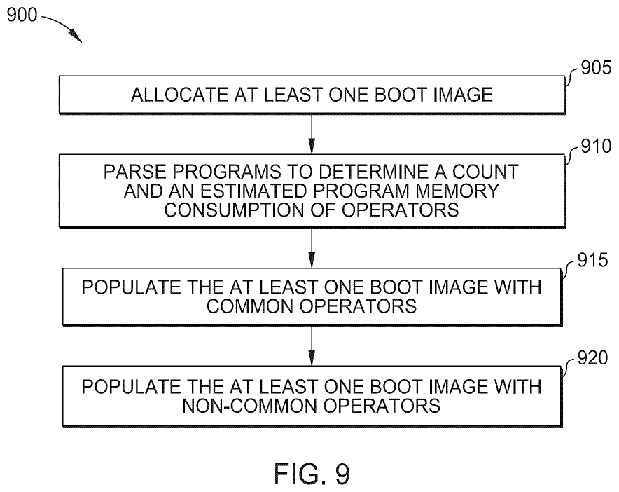

FIG. 9 illustrates a method 900 for partitioning programs to be executed in an hardware accelerator circuitry such as hardware accelerator circuitry 120, according to one or more examples. In one or more examples, the method 900 is performed by the CPU 105. Stated differently, the CPU 105 includes a non-transitory computer readable medium that causes the CPU 105 to perform the methods described herein.

At operation 905 of the method 900, and as illustrated in FIG. 3A, the CPU 105 allocates at least one boot image in the memory 135. For example, as shown in FIG. 3A, the CPU 105 allocates boot images 308 and 310 within the memory 135. Although two boot images are allocated by the CPU 105, this is for example purposes only, and any suitable quantity of boot images may be allocated. In one or more examples, the at least one allocated boot image has a size (capacity) equal to the program memory size limit.

At operation 910 of the method 900, and as illustrated in FIG. 3A, the CPU 105 parses the programs stored in a memory that are provided to the CPU 105 to determine an estimated program memory consumed by each operator and generates a count corresponding to each operator. The count corresponding to each operator indicates how many times the CPU 105 detects each program and is stored in a memory. For example, the operator k1 is included once in each of the programs 302-306, and therefore, the count for the operator k1 is 3. The count for the operator k2 is equal to 2 because operator k2 in included in the programs 302 and 304. The count for the operators k3-k6 is each 1. The operator k3 is included once in the program 306. The operator k4 is included once in the program 304. The operator k5 is included once in the program 302. The operator k6 is included once in the program 306.

At operation 915 of the method 900, and as illustrated in FIG. 3B the CPU 105 populates the at least one boot image with common operators. The CPU populates the least one boot image based on the sum of the estimated program memory consumption of the common operators. In one or more examples, common operators are operators that are within a threshold count. For example, if the threshold count is equal to 2, the operator k1 and the operator k2 are common operators. Each of the common operators are added to each boot image so long as the sum of the sum of the estimated program memory consumption of the common operators is less than the program memory size limit of the hardware accelerator circuitry. This is described in more detail in method 200 of FIGS. 2A-2B described below. For example, as illustrated in FIG. 3B the operator k1 and the operator k2 are added to boot images 308 and 310 because the sum of the estimated program memory of the operator k1 and the operator k2 is less than 16 KB.

At operation 920 of the method 900, and as illustrated in FIGS. 3C-3D the CPU 105 populates each of the boot images with non-common operators. In one or more examples, CPU 105 populates each of the boot images with non-common operators based on the sum the sum of the estimated program memory consumption of the common operators already in the boot images and the non-common operator(s). For example, as shown in FIG. 3C, the operator k3 is added to the boot image 308 because the sum of the estimated program memory consumption of the operators k1 and k2 (the common operators) and the operator k3 (the non-common operator) is 16 KB, and is therefore, equal to the program memory size limit. As shown in FIG. 3D, the operator k4 is added to the boot image 310 because the sum of the estimated program memory consumption of the operators k1 and k2 (the common operators) and the operator k4 (the non-common operator) is 16 KB, and is therefore, equal to the program memory size limit. Furthermore, because the operator k5 has a size limit of 5 KB and the operator k6 has a size limit of 12 KB the operators, the operators k5 and k6 can not be added to the boot images 308 and 310 because it would place both boot images over the program memory size limit of the hardware accelerator circuitry 120. Therefore, as will be described in more detail below, additional boot images are allocated and populated so that the non-common operators that cannot fit in the at least one already allocated boot images are accounted for in a boot image.

While the foregoing is directed to specific examples, other and further examples may be devised without departing from the basic scope thereof, and the scope thereof is determined by the claims that follow.

What is claimed is:

1. A method comprising:
allocating, by a central processing unit (CPU) of an integrated circuit (IC) device, at least one boot image in a memory coupled to the IC device;
parsing, by the CPU, programs comprising one or more operators and determining a count corresponding to each operator included in each program and an estimated program memory consumption of each operator, the count corresponding to each operator indicating a quantity of times the CPU detects each operator in each program;
populating, by the CPU, the at least one boot image with common operators based on a program memory size limit of an hardware accelerator circuitry of the IC device and an estimated program memory consumption of each common operator, wherein the common operators are operators that are within a threshold count; and
populating, by the CPU, the at least one boot image with non-common operators based on the program memory size limit of the hardware accelerator circuitry and an estimated program memory consumption of each non-common operator, wherein the non-common operators are operators that are not within the threshold count.

2. The method of claim 1, further comprising allocating and populating by the CPU, an additional boot image with non-common operators based on determining at least one of the non-common operators is not included in the at least one boot image and the non-common operators do not fit within the at least one boot image based on the program memory size limit of the hardware accelerator circuitry.

3. The method of claim 1, wherein determining the count corresponding to each operator comprises generating a histogram.

4. The method of claim 1, wherein populating the at least one boot image with the common operators based on the program memory size limit of the hardware accelerator circuitry and the estimated program memory consumption of each common operator further comprises:
determining by the CPU, a sum of each estimated program memory consumption of each common operator; and
populating by the CPU, the at least one boot image with each common operator if the estimated program memory consumption of each common operator is less than the program memory size limit of the hardware accelerator circuitry.

5. The method of claim 1, wherein populating the at least one boot image with the non-common operators based on the program memory size limit of the hardware accelerator circuitry and the estimated program memory consumption of each non-common operator further comprises adding by the CPU, a non-common operator to a boot image based on determining that a sum between the estimated program memory consumption of the non-common operator and the common operators already stored in the boot image is less than or equal to the program memory size limit of the hardware accelerator circuitry.

6. The method of claim 2, wherein allocating and populating the additional boot image with the non-common operators comprises:
determining by the CPU, that a non-common operator is not included in the at least one boot image;
allocating by the CPU, the additional boot image based on determining that the non-common operator does not fit within a boot image; and
adding by the CPU, the non-common operator in the additional boot image.

7. The method of claim 6, further comprising:
determining by the CPU, that an additional non-common operator is not included in the at least one boot image; and
adding by the CPU, the additional non-common operator in the additional boot image based on determining that the additional boot image is not at capacity.

8. The method of claim 6, further comprising:
determining by the CPU, that a further non-common operator is not included in a boot image;
allocating by the CPU, a further additional boot image based on determining that the additional boot image is at capacity; and
adding by the CPU, the further non-common operator in the further additional boot image.

9. The method of claim 1, further comprising:
parsing, by the CPU, a to be executed program comprising the one or more operators, wherein the to be executed program is configured to be executed in the hardware accelerator circuitry;
generating, by the CPU, a working set based on the parsing, the working set comprising the one or more operators of the to be executed program;
determining, by the CPU, intersection scores for each of the at least one boot image based on the working set;
selecting, by the CPU, a best boot image based on the intersection scores;
updating, by the CPU, the working set by removing each of the operators included in the best boot image from the working set;
determining, by the CPU, additional intersection scores for each of the at least one boot image based on the updated working set;
selecting, by the CPU, an additional best boot image based on the additional intersection scores; and
repeating the updating of the working set, the determining of the additional intersection scores, and the selecting of the additional best boot image until the working set is empty.

10. A system, comprising:
a hardware accelerator circuitry;
a central processing unit (CPU) coupled to the hardware accelerator circuitry; and
a memory coupled to the CPU and the hardware accelerator circuitry, wherein the CPU is configured to:
allocate at least one boot image in the memory;
parse programs comprising one or more operators and determine a count corresponding to each operator included in each program and an estimated program memory consumption of each operator, the count corresponding to each operator indicating a quantity of times the CPU detects each operator in each program;
populate the at least one boot image with common operators based on a program memory size limit of the hardware accelerator circuitry and an estimated program memory consumption of each common operator, wherein the common operators are operators that are within a threshold count; and
populate the at least one boot image with non-common operators based on the program memory size limit of the hardware accelerator circuitry and an estimated program memory consumption of each non-common operator, wherein the non-common operators are operators that are not within the threshold count.

11. The system of claim 10, wherein the CPU is further configured to allocate and populate an additional boot image with non-common operators based on determining at least one of the non-common operators is not included in the at least one boot image and the non-common operators do not fit within the at least one boot image based on the program memory size limit of the hardware accelerator circuitry.

12. The system of claim 10, wherein determining the count corresponding to each operator comprises generating a histogram.

13. The system of claim 10, wherein populating the at least one boot image with the common operators based on the program memory size limit of the hardware accelerator circuitry and the estimated program memory consumption of each common operator further comprises:
determining a sum of each estimated program memory consumption of each common operator; and
populating the at least one boot image with each common operator if the estimated program memory consumption of each common operator is less than the program memory size limit of the hardware accelerator circuitry.

14. The system of claim 11, wherein populating the at least one boot image with non-common operators based on the program memory size limit of the hardware accelerator circuitry and an estimated program memory consumption of each non-common operator further comprises:
adding a non-common operator to a boot image based on determining that a sum between the estimated program memory consumption of the non-common operator and the common operators already included in the boot image is less than or equal to the program memory size limit of the hardware accelerator circuitry.

15. The system of claim 11, wherein allocating and populating the additional boot image with the non-common operators comprises:
determining that a non-common operator is not included in the at least one boot image;
allocating the additional boot image based on determining that the non-common operator does not fit within the at least one boot image; and
adding the non-common operator in the additional boot image.

16. The system of claim 15, wherein the CPU is further configured to:
determine that an additional non-common operator is not included in the at least one boot image and the additional boot image; and
add the additional non-common operator in the additional boot image based on determining that the additional boot image is not at capacity.

17. The system of claim 16, wherein the CPU is further configured to:
determine that a further non-common operator is not included in the at least one boot image and the additional boot image;
allocate a further additional boot image based on determining that the additional boot image is at capacity; and
add the further non-common operator in the further additional boot image.

18. The system of claim 10, wherein the CPU is further configured to:
parse the program comprising the one or more operators to be executed in the hardware accelerator circuitry;
generate, by the CPU, a working set based on the parsing, the working set comprising the one or more operators of the program;
determine intersection scores for the at least one boot image based on the working set;
select a best boot image based on the intersection scores;
generate an updated working set by removing each of the operators included in the best boot image from the working set;
determine additional intersection scores for the at least one boot image based on the updated working set;
select an additional best boot image based on the additional intersection scores; and
repeat the generating of the updated working set, the determining of the additional intersection scores, and the selecting of the additional best boot image until the working set is empty.

19. A central processing unit (CPU) comprising a non-transitory computer readable medium configured to cause the CPU to perform a method comprising:
allocating at least one boot image in a memory coupled to an IC device;
parsing programs comprising one or more operators and determining a count corresponding to each operator included in each program and an estimated program memory consumption of each operator, the count corresponding to each operator indicating a quantity of times the CPU detects each operator in each program;
populating the at least one boot image with common operators based on a program memory size limit of an hardware accelerator circuitry of the IC device and an estimated program memory consumption of each common operator, wherein the common operators are operators that are within a threshold count; and
populating the at least one boot image with non-common operators based on the program memory size limit of the hardware accelerator circuitry and an estimated program memory consumption of each non-common operator, wherein the non-common operators are operators that are not within the threshold count.

20. The CPU of claim 19, wherein the method further comprises:
parsing a to be executed program comprising the one or more operators, wherein the to be executed program is configured to be executed in the hardware accelerator circuitry;
generating a working set based on the parsing, the working set comprising the one or more operators of the to be executed program;
determining intersection scores for the at least one boot image based on the working set;
selecting a best boot image based on the intersection scores of the at least one boot image;
updating the working set by removing each of the operators included in the best boot image from the working set;
determining additional intersection scores for the at least one boot image based on the updated working set;
selecting an additional best boot image based on the additional intersection scores of the at least one boot image; and
repeating the updating of the working set, the determining of the additional intersection scores, and the selecting of the additional best boot image until the working set is empty.
